(19) United States
(12) Patent Application Publication
(10) Pub. No.: US 2024/0337045 A1
(43) Pub. Date: Oct. 10, 2024

(54) FIBERS AND COMPOSITES USING TAILORED NATURAL FIBER PRECURSOR MATERIALS

(71) Applicant: GM GLOBAL TECHNOLOGY OPERATIONS LLC, Detroit, MI (US)

(72) Inventors: Mohammad Hamza KIRMANI, Troy, MI (US); Bradley Allen NEWCOMB, Troy, MI (US)

(21) Appl. No.: 18/130,557

(22) Filed: Apr. 4, 2023

(51) Int. Cl. D01C 1/02; D02G 1/16; D02G 3/04

(52) U.S. Cl. CPC D01C 1/02; D02G 1/164; D02G 3/04

(57) ABSTRACT

A method for creating a fiber includes obtaining constituent natural fiber components by breaking down at least one of fresh natural fibers, fibers extracted after post-industrial use, fibers extracted after post-consumer use, and combinations thereof. The constituent natural fiber components comprise at least one material selected from a group consisting of cellulose, pectin, hemicellulose, lignin, and wax. The method includes separating the constituent natural fiber components into N natural fiber precursors, where N is an integer greater than one; creating a mixture of the N natural fiber precursors using a predetermined ratio of the N natural fiber precursors; and creating at least one of fiber and yarn using the mixture.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to reinforcing fibers, and more particularly to reinforcing fibers made using tailored natural fiber precursors and composites using the reinforcing fibers.

Natural fibers include bast, leaf, seed, wood, and grass stem. Bast fibers include flax, hemp, jute, ramie, and kenaf. To increase sustainability and renewability, natural fibers may be used instead of other types of reinforcing fibers such as carbon fibers or glass fibers when manufacturing structural and semi-structural composite components.

### SUMMARY

A method for creating a fiber includes obtaining constituent natural fiber components by breaking down at least one of fresh natural fibers, fibers extracted after post-industrial use, fibers extracted after post-consumer use, and combinations thereof. The constituent natural fiber components comprise at least one material selected from a group consisting of cellulose, pectin, hemicellulose, lignin, and wax. The method includes separating the constituent natural fiber components into N natural fiber precursors, where N is an integer greater than one; creating a mixture of the N natural fiber precursors using a predetermined ratio of the N natural fiber precursors; and creating at least one of fiber and yarn using the mixture.

In other features, at least one of the N natural fiber precursors is extracted using a chemical treatment. The chemical treatment of the at least one of the N natural fiber precursors includes using one or more treatments selected from a group consisting of using an acid, using a base, a thermal treatment, a mechanical treatment, a dewaxing treatment, a chemical treatment, hydrolysis, fractionation, pulping, bleaching, and combinations thereof.

In other features, the method includes creating at least one of a dispersion, solution, a paste, a gel, and a dough including the N natural fiber precursors and one or more solvents. The at least one of the dispersion, the solution, the paste, the gel, and the dough has a concentration of the N natural fiber precursors in a range from 0.01 mg/ml to 100 mg/ml. The at least one of the dispersion, the solution, the paste, the gel, and the dough is prepared using a process selected from a group consisting of mechanical mixing, shear mixing, sonication, homogenizing, and combinations thereof.

In other features, the method includes enhancing at least one of a chemical interaction and a physical interaction between the N natural fiber precursors and the one or more solvents by at least one of increasing a concentration of the one or more solvents; and adding a binder that at least one of physically and chemically crosslinks with at least one of the N natural fiber precursors.

In other features, at least one of the dough and the gel of the N natural fiber precursors is prepared via electrophoretic deposition of precursors dispersed in a solution. The method includes manufacturing at least one of fibers and yarns using the N natural fiber precursors and the one or more solvents. The method includes extruding the N natural fiber precursors and the one or more solvents through a spinneret to create a fiber. The method includes at least one of drying and coagulating the fiber.

In other features, the method includes applying at least one of a spin draw ratio during formation of the fiber and a post spin draw ratio. The N natural fiber precursors and the one or more solvents are coextruded with at least one of a polymer solution and a gel. The fiber includes a hollow core after the extruding.

In other features, the method includes fabricating a multicomponent continuous yarn. At least one component of the multicomponent continuous yarn is made using the at least one of the dispersion, the solution, the paste, the gel, and the dough, and another component of the multicomponent continuous yarn is made using at least one of a second solution and a second gel comprising a material selected from a group consisting of a polymer, ceramic, carbon nanotubes, boron nitride nanotubes, or combinations thereof.

In other features, the at least one of the dispersion, the solution, the paste, the gel, and the dough and the at least one of the second solution and the second gel are extruded through a spinneret and at least one of dried and coagulated to form a yarn.

In other features, the method includes fabricating a composite panel including the fiber and resin. The method includes weaving a fabric using the fiber. The method includes fabricating a composite panel including the fiber and resin. The method includes weaving a fabric using the fiber.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a flowchart of an example of a method for fabricating reinforcing fibers using tailored natural fiber precursors according to the present disclosure;

FIG. 2A illustrates an example of a method for fabricating reinforcing fibers using tailored natural fiber precursors according to the present disclosure;

FIG. 2B is a side cross-sectional view of a natural fiber;

FIGS. 2C to 2L are examples side cross-sectional view fibers made using tailored natural fiber precursors according to the present disclosure; and

FIG. 3 illustrates an example of a method for fabricating reinforcing fibers using tailored natural fiber precursors according to the present disclosure.

In the drawings, reference numbers may be reused to identify similar and/or identical elements.

### DETAILED DESCRIPTION

While reinforcing fibers made using tailored natural fiber precursors and composite panels using the reinforcing fibers are described below in the context of vehicle applications, the reinforcing fibers and the composites such as panels, parts, or other structures using the reinforcing fibers can be used in stationary or other types of applications.

Natural fibers include jute, hemp, kenaf, flax, ramie, sunn, sisal, henquen, cotton, kapok, coir, banana, etc. The natural fibers include varying compositions of cellulose (e.g., 30 to 85 wt %), lignin (e.g., 0 to 45 wt %), hemicellulose (e.g., 4 to 25 wt %), pectin (e.g., 0 to 23 wt %), wax (e.g., 0 to 3 wt %), and moisture (e.g., 0 to 15 wt %). In addition, natural fibers that are of the same natural fiber type have variable compositions due to differences in weather during the growing season and/or other factors. For example, hemp may include cellulose in a range from 70.2 wt % to 74.4 wt %, lignin in a range from 3.7 wt % to 5.7 wt %, and hemicellulose in a range from 17.9 wt % to 22.4 wt % (and other materials with less variation). The variations in composition affect the strength of the natural fibers. The natural fibers may also have variations in kinks and/or defects. Variations in composition, kinks, defects, and other properties of the natural fibers lead to variations in the strength of the reinforcing fibers made using the natural fibers. This variation in strength makes it difficult to use natural fibers in structural composite panels.

The present disclosure relates to a method for breaking down natural fibers into their constituent natural fiber components (e.g., cellulose, lignin, hemicellulose, pectin, wax, and moisture), separating the constituent natural fiber components into natural fiber precursors, and creating reinforcing fibers from the natural fiber precursors. For example, the reinforcing fibers are made using a predetermined recipe defining a predetermined mixture of the natural fiber precursors based on the constituent natural fiber components recovered from the natural fibers.

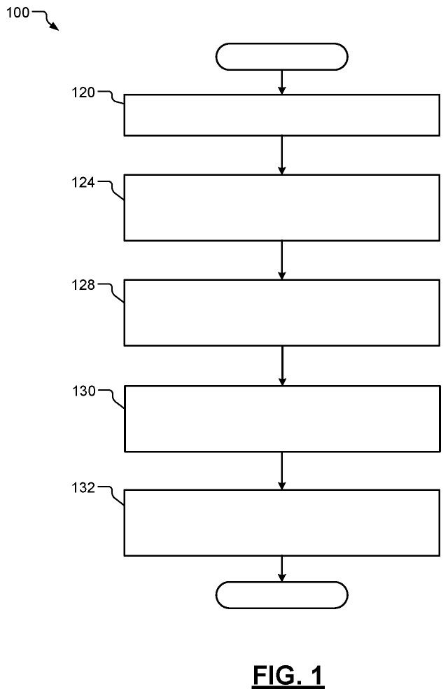

Referring now to FIG. 1, a method 100 is shown for fabricating reinforcing fibers using natural fiber precursors (e.g., cellulose, lignin, hemicellulose, pectin, wax, and moisture). At 120, natural fibers are broken down into constituent natural fiber components. At 124, the constituent natural fiber components (e.g., cellulose, lignin, hemicellulose, pectin, wax, and moisture) are separated into natural fiber precursors. At 128, dispersions, solutions, pastes, gels, and/or doughs are made using the natural fiber precursors. At 130, one or more of the dispersions, solutions, pastes, gels, and/or doughs are mixed into one or more predetermined mixtures. At 132, fibers and/or yarns are spun using the one or more predetermined mixtures.

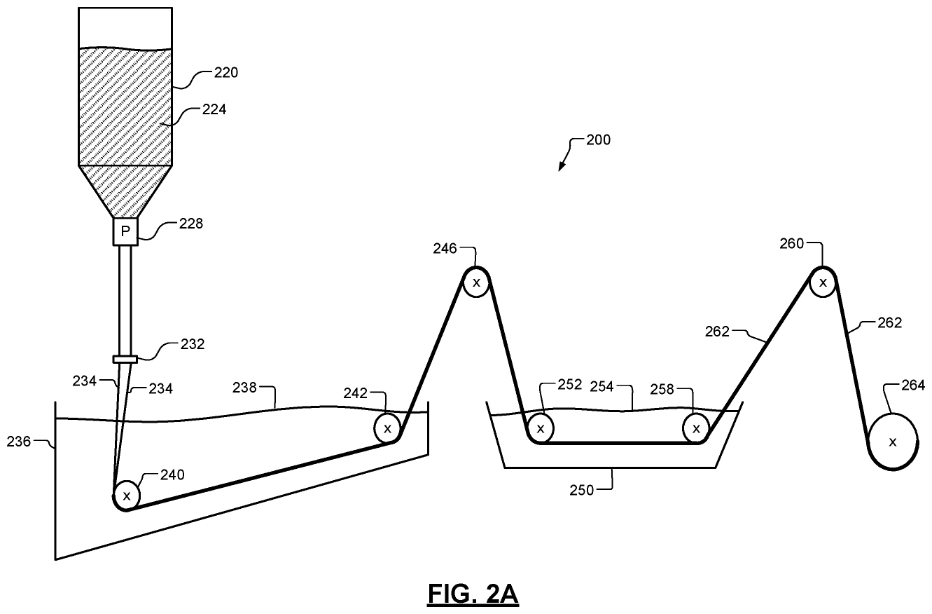

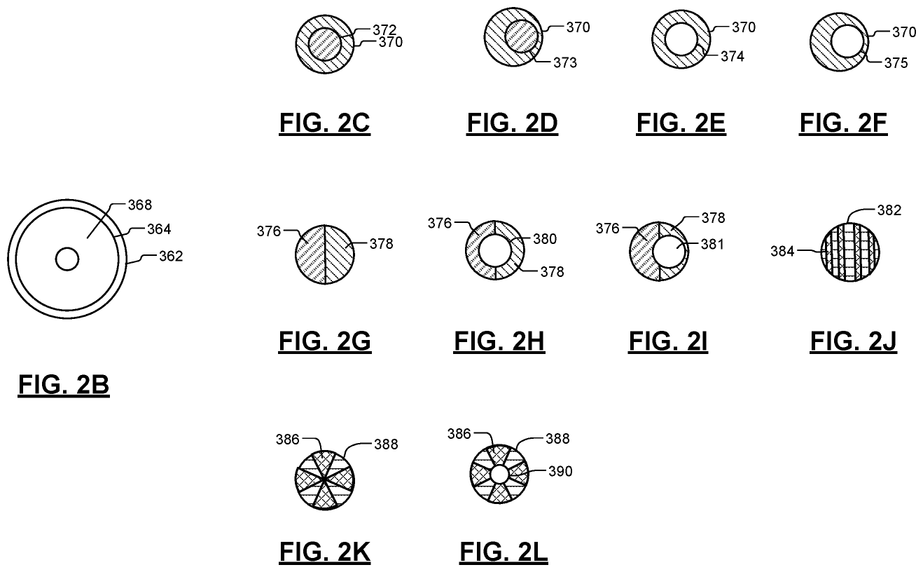

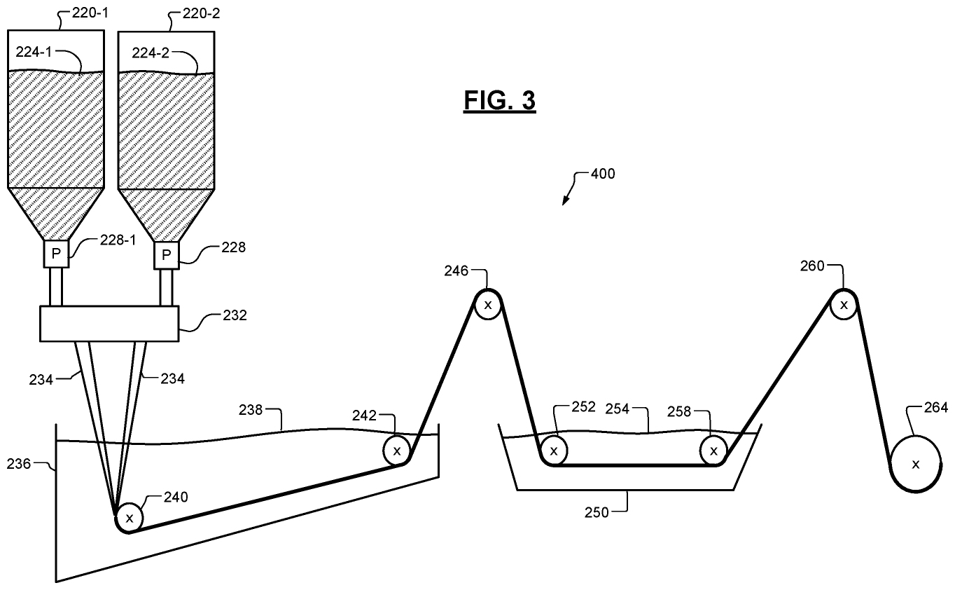

Referring now to FIG. 2A, a system 200 for extruding fibers is shown. A mixture 224 is supplied by a container 220 to a pump 228. The pump 228 outputs one or more aqueous suspensions of a fiber 234 of the mixture 224 to a spinneret 232. The spinneret 232 is a device used to extrude a solution or melt including a mixture of the constituent natural fiber precursors to form fiber filaments. Streams of viscous mixture exit the spinneret 232 into air or liquid leading to a phase inversion which allows the fiber filaments to solidify. The individual polymer chains tend to align in the fiber because of viscous flow.

The spinneret 232 generally includes a thimble-shaped, metal nozzle having fine holes through which a spinning solution is forced to form a filament. The fiber filaments are solidified by coagulation, evaporation, and/or cooling. The size and shape of the holes in the spinneret 232 determine the filament's cross-sectional shape. Each hole forms a fiber.

In some examples, the spinneret 232 may be supplied a single mixture. In other examples, the spinneret 232 includes separate chambers that are supplied with two or more mixtures and feed separate sets of holes with different arrangements to provide different fiber regions with the fiber. The different fiber regions have different compositions or mixtures of the natural fiber precursors as will be described further below in FIGS. 2C to 2L.

In some examples, the spinneret 232 defines an air gap between an end of the spinneret 232 and a surface of liquid 238 in a bath 236. Solvent in the one or more fibers 234 is removed by the liquid 238 in the bath 236. For example, the fiber 234 may pass over rollers 240 and 242 in the bath 236. Additional washing, drying, and/or stretching steps may occur during fiber formation. For example, the fiber 234 may pass over a roller 246 and into a washing bath 250 including a liquid 254. In some examples, the fiber passes over rollers 252 and 258 in the liquid 254 to wash the fiber 234. Fibers 262 that are washed pass over a roller 260 and are collected on a roll 264.

As can be appreciated, the fibers 262 may have a uniform cross section and a homogenous composition. In other examples, the fibers 262 may have different regions with different compositions of the natural fiber precursors.

Referring now to FIG. 2B, natural fibers are not comprised of a single macromolecule like synthetic fibers produced from a single component fiber spinning device. The natural fibers typically include a primary cell wall 362, a secondary cell wall 364, and a tertiary cell wall 368. For example, the tertiary cell wall 368 may include cellulose microfibrils, RG-I, and/or other constituents (mannan, AGP). For example, the secondary cell wall 364 may include xylan, lignin, and/or cellulose microfibrils. For example, the primary cell wall 362 may include pectins, xyloglucan, and/or cellulose microfibrils.

Referring now to FIGS. 2C to 2L, various different cross-sections of fibers that are made from one or more mixtures of natural fiber precursors as described herein are shown. In FIG. 2C, a fiber includes a first region 372 centered within a second region 370. The first region 372 and the second region 370 have different compositions of the natural fiber precursors.

In FIG. 2D, a fiber includes a first region 373 offset to one side of a second region 370. The first region 373 and the second region 370 have different compositions of the natural fiber precursors. In FIG. 2E, a fiber includes a first region 374 centered within the second region 370. The first region 374 is hollow and the second region 370 includes a mixture of the natural fiber precursors. In FIG. 2F, a fiber includes a first region 375 offset within the second region 370. The first region 375 is hollow and the second region 370 includes a mixture of the natural fiber precursors.

In FIG. 2G, a fiber includes a first region 376 on one side and a second region 378 adjacent thereto. The first region 376 and the second region 378 have different compositions of the natural fiber precursors. In FIG. 2H, a fiber includes the first region 376 on one side, the second region 378 adjacent thereto, and a third region 380 that is centered and hollow. The first region 376 and the second region 378 have different compositions of the natural fiber precursors. In FIG. 2I, a fiber includes the first region 376 on one side, the second region 378 adjacent thereto, and a third region 381 that is offset from center and hollow.

In FIG. 2J, a fiber includes first regions 382 and second regions 384 adjacent thereto to create a striped pattern. The first region 382 and the second region 384 have different compositions of the natural fiber precursors. In FIG. 2K, a fiber includes the first regions 386 and second regions 388 that are adjacent thereto. In this example, the first regions 386 and the second regions 388 are pie shaped. In FIG. 2L, the fiber of FIG. 2K further includes a hollow centered (or offset) region 390.

Referring now to FIG. 3, another system 400 for extruding fibers is shown. Two or more fibers that are homogenous or have regions with different compositions can be interwound. Mixtures 224-1 and 224-2 are supplied by containers 220-1 and 220-2 to pumps 228-1 and 228-2, respectively. The pump 228-1 outputs one or more aqueous suspensions of a fiber 234-1 of the mixture 224-1 to a spinneret 232-1. The pump 228-2 outputs one or more aqueous suspensions of a fiber 234-2 of the mixture 224-2 to a spinneret 232-2. The spinneret 232-2 outputs fibers 234-2 that are interwound with the fibers 234-1.

As can be appreciated, one or both of the fibers 234-1 and 234-2 may have a uniform cross section and a homogenous composition. In other examples, one or both of the fibers 234-1 and 234-2 may have two or more different regions with different compositions as described above in FIGS. 2C to 2L.

In some examples, one or both of the fibers include predetermined amounts of natural fiber precursors comprising of cellulose, pectin, hemicellulose, lignin, wax, or combinations thereof. The natural fiber precursors are obtained from fresh natural fibers, fibers extracted after their post-industrial or consumer use, and/or combinations thereof.

In some examples, the natural fiber precursors are extracted using one or more chemical treatments (including treatment with organic solvents), acids, bases, thermal treatment, mechanical treatment, dewaxing, chemicals (including sodium hydroxide, sodium sulfide, anthraquinone), hydrolysis, fractionation, pulping, bleaching, and/or combinations thereof.

In some examples, a dispersion, solution or paste of natural fiber precursors comprises cellulose, pectin, hemicellulose, lignin, wax, or combinations and one or more solvents. In some examples, the dispersion, solution or paste has a concentration between 0.01 mg/ml to 100 mg/ml. In some examples, the dispersion, solution or paste is prepared using mechanical mixing, shear mixing, sonication, homogenization, or combinations thereof.

In other examples, gels or dough of natural fiber precursors comprise cellulose, pectin, hemicellulose, lignin, wax, or combinations and one or more solvents. The gels are prepared by enhancing the chemical or physical interactions between the natural fiber precursors and the solvent in the dispersion, solution or paste. In some examples, the interactions between the natural fiber precursors and the solvent are enhanced by increasing the solvent concentration. In some examples, the interactions between the natural fiber precursors and the solvent are enhanced by adding binders that physically or chemically crosslink the precursor materials in the solution. In some examples, the gels or dough are prepared via electrophoretic deposition of precursors dispersed in solutions. In some examples, the dispersion, solution, paste, gels, and/or dough comprise liquid crystals.

The dispersion, solution, paste, gels, and/or dough are used to spin fibers or yarns. The dispersion, solution, paste, gels, and/or dough are extruded through a spinneret and formed into a fiber or a yarn via drying or coagulation or both. In some examples, a spin draw ratio is applied during the formation of the fiber. A post spin draw ratio is applied as a means of increasing orientation.

In some examples, continuous fibers or yarns have tailored cross-sectional geometries, bulk densities and/or functionalities. In some examples, the dispersion, solution, paste, gels, and/or dough are coextruded with a polymer solution or gel.

In some examples, the fiber or yarn has a hollow core. In some examples, multicomponent continuous yarns are fabricated where at least one component is made using dispersions, solutions, paste, gels, and/or dough of natural fiber precursors and the other components are made using solutions or gels of at least one type of polymer, ceramic, carbon nanotubes, boron nitride nanotubes or combinations thereof.

In other examples, the solutions or gels of different natural fiber precursors are extruded through a spinneret and formed into a yarn via drying or coagulation or both. In some examples, the fibers and yarns do not have kinks and/or the kinks are on separated by more than 100 μm on average.

In some examples, the fibers and yarns have a thermal conductivity of up to 500 W/m-K. In some examples, the fibers and yarns have a total moisture absorption in a range from 0.1 wt % to 10 wt %. In some examples, the fibers and yarns have an electrical conductivity of less than or equal to 10⁶ S/m. In some examples, the fibers and yarns have tensile strength less than or equal to 10 GPa and tensile modulus of 300 GPa. In some examples, the fibers and yarns are flame resistant (e.g., a sheath of multicomponent fiber is made from polybenzimidazole, Kevlar)

In other examples, woven and non-woven fabrics are produced from fibers. In other examples, a composite panel includes resin and reinforced fibers or fabric including the reinforcing fibers described herein.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for creating a fiber, comprising:
obtaining constituent natural fiber components by breaking down at least one of fresh natural fibers, fibers extracted after post-industrial use, fibers extracted after post-consumer use, and combinations thereof,
wherein the constituent natural fiber components comprise at least one material selected from a group consisting of cellulose, pectin, hemicellulose, lignin, and wax;
separating the constituent natural fiber components into N natural fiber precursors, where N is an integer greater than one;
creating a mixture of the N natural fiber precursors using a predetermined ratio of the N natural fiber precursors; and
creating at least one of fiber and yarn using the mixture.

2. The method of claim 1, wherein at least one of the N natural fiber precursors is extracted using a chemical treatment.

3. The method of claim 2, wherein the chemical treatment of the at least one of the N natural fiber precursors includes using one or more treatments selected from a group consisting of using an acid, using a base, a thermal treatment, a mechanical treatment, a dewaxing treatment, a chemical treatment, hydrolysis, fractionation, pulping, bleaching, and combinations thereof.

4. The method of claim 1, further comprising creating at least one of a dispersion, solution, a paste, a gel, and a dough including the N natural fiber precursors and one or more solvents.

5. The method of claim 4, wherein the at least one of the dispersion, the solution, the paste, the gel, and the dough has a concentration of the N natural fiber precursors in a range from 0.01 mg/ml to 100 mg/ml.

6. The method of claim 4, wherein the at least one of the dispersion, the solution, the paste, the gel, and the dough is prepared using a process selected from a group consisting of mechanical mixing, shear mixing, sonication, homogenizing, and combinations thereof.

7. The method of claim 4, further comprising enhancing at least one of a chemical interaction and a physical interaction between the N natural fiber precursors and the one or more solvents by at least one of:
increasing a concentration of the one or more solvents; and
adding a binder that at least one of physically and chemically crosslinks with at least one of the N natural fiber precursors.

8. The method of claim 4, wherein at least one of the dough and the gel of the N natural fiber precursors is prepared via electrophoretic deposition of precursors dispersed in a solution.

9. The method of claim 4, further comprising manufacturing at least one of fibers and yarns using the N natural fiber precursors and the one or more solvents.

10. The method of claim 4, further comprising extruding the N natural fiber precursors and the one or more solvents through a spinneret to create a fiber.

11. The method of claim 10, further comprising at least one of drying and coagulating the fiber.

12. The method of claim 10, further comprising applying at least one of a spin draw ratio during formation of the fiber and a post spin draw ratio.

13. The method claim 10, wherein the N natural fiber precursors and the one or more solvents are coextruded with at least one of a polymer solution and a gel.

14. The method of claim 10, wherein the fiber includes a hollow core after the extruding.

15. The method of claim 4, further comprising:
fabricating a multicomponent continuous yarn,
wherein at least one component of the multicomponent continuous yarn is made using the at least one of the dispersion, the solution, the paste, the gel, and the dough, and
wherein another component of the multicomponent continuous yarn is made using at least one of a second solution and a second gel comprising a material selected from a group consisting of a polymer, ceramic, carbon nanotubes, boron nitride nanotubes, or combinations thereof.

16. The method of claim 15, wherein the at least one of the dispersion, the solution, the paste, the gel, and the dough and the at least one of the second solution and the second gel are extruded through a spinneret and at least one of dried and coagulated to form a yarn.

17. The method of claim 11, further comprising fabricating a composite panel including the fiber and resin.

18. The method of claim 11, further comprising weaving a fabric using the fiber.

19. A method for creating a fiber, comprising:
obtaining constituent natural fiber components by breaking down at least one of fresh natural fibers, fibers extracted after post-industrial use, fibers extracted after post-consumer use, and combinations thereof,
wherein the constituent natural fiber components comprise at least one material selected from a group consisting of cellulose, pectin, hemicellulose, lignin, and wax;
separating the constituent natural fiber components into N natural fiber precursors, where N is an integer greater than one;
creating a mixture of the N natural fiber precursors using a predetermined ratio of the N natural fiber precursors;
mixing the N natural fiber precursors and one or more solvents;
extruding the N natural fiber precursors and the one or more solvents through a spinneret to create a fiber;
at least one of drying and coagulating the fiber.

20. The method of claim 19, further comprising:
arranging the fiber in a predetermined pattern; and
encapsulating the fiber in a resin to create a composite.
